(19) United States
(12) Patent Application Publication
(10) Pub. No.: US 2013/0041056 A1
(43) Pub. Date: Feb. 14, 2013

(54) POLYMETHACRYLIMIDE FOAM MATERIALS HAVING REDUCED FLAMMABILITY AND METHOD FOR PRODUCING SAME

(71) Applicants: Werner Geyer, Brensbach (DE); Kay Bernhard, Darmstadt (DE); Mathias Hempler, Freigericht (DE); Thomas Barthel, Heppenheim (DE)

(72) Inventors: Werner Geyer, Brensbach (DE); Kay Bernhard, Darmstadt (DE); Mathias Hempler, Freigericht (DE); Thomas Barthel, Heppenheim (DE)

(73) Assignee: Evonik Roehm GmbH, Darmstadt (DE)

(21) Appl. No.: 13/640,427

(22) PCT Filed: Mar. 3, 2011
(86) PCT No.: PCT/EP2011/053138

§ 371 Date: Oct. 10, 2012

(30) Foreign Application Priority Data
May 6, 2010 (DE) 102010028695.8

(51) Int. Cl. C08L 33/22; C08K 5/20; C08K 5/5393

(52) U.S. Cl. 521/85

(57) ABSTRACT

The invention relates to compositions for producing poly(meth)acrylamide foam materials having particularly reduced flammability. The present invention further relates to a method for the production, the processing and the use thereof.

### FIELD OF THE INVENTION

The invention relates to compositions for production of polymethacrylimide foams with particularly reduced flammability. The present invention further relates to the process for production thereof, and to processing and use thereof.

Polymethacrylimide foams (PMI foams) have already been known for a long time. Under the ROHACELL® tradename, these foams find many applications, especially in the sector of laminate materials. These applications include, for example, processing to laminates, composites, foam composites, sandwich constructions or sandwich materials. Laminate materials are shaped bodies formed from an outer top layer and an inner core material. The top layers used are materials which can absorb extremely high tensile forces in a uni- or multiaxial manner. Examples are glass fibre and carbon fibre fabrics, or else aluminium sheets which are fixed to the core material with adhesive resins. The core materials used are preferably materials with low densities, typically in the range from 30 kg/m³ to 200 kg/m³. Particular significance is possessed by such materials in lightweight construction, especially in aircraft or vehicle construction. Specifically in these fields of application, an additional factor of great significance is the nonflammability of the materials.

### STATE OF THE ART

According to the prior art, polymer foams based on polymethacrylimide (PMI) are stabilized with dimethyl methanephosphonates (DMMP), especially in a concentration of approx. 10% by weight; see EP 0 146 892, in which DMMP and functionalized DMMP are disclosed as flame retardants for polymethacrylimide. However, DMMP has now been identified as mutagenic, and so there is a great need to replace DMMP as a flame retardant, in particular for PMI foams.

It is common knowledge, however, to the person skilled in the art that polymethacrylimide foams in particular are sensitive systems and can be optimized only with difficulty in relation to the foaming behaviour. For instance, number of commercial flame-retardant stabilizers reduce or prevent foamability in such foam formulations.

The list of commercial flame retardants for other applications is very long. In addition to halogenated flame retardants, some of which contain antimony oxides, it is also possible to use phosphorus compounds. Phosphorus compounds are preferred owing to the lower smoke gas toxicity in the event of fire. The phosphorus compounds include phosphines, phosphine oxides, phosphonium compounds, phosphonates, phosphites and/or phosphates. These compounds may be of organic and/or inorganic nature.

However, there has been no description to date in the prior art of a flame retardant which enables similarly good properties of the PMI foam with regard to comparable flame retardancy and mechanical properties.

For other polymer foams, in contrast, various flame retardants have been described. For instance, it is possible to stabilize methacrylonitrile/acrylonitrile foams, according to CN 101 544 720, with chlorinated flame retardants. However, the use of chlorinated systems is not preferable for various reasons, specifically also in connection with flame retardancy or for reasons of health protection.

EP 1 501 891 describes phosphorus compounds in general for the flame-retardant modification of polyurethane foams.

EP 2 152 834 details alkyl dimethyl phosphonates for improving flame retardancy of epoxy resins, polyesters or polyurethanes. The use of dimethyl propyl phosphonate (DMPP) specifically for polyurethane foams can be found in DE 44 183 07 or in CN 101 487 299. (Meth)acrylimides are not described as a matrix material in any of these documents.

### PROBLEM

Against the background of the prior art, the problem was to find a new flame retardant for polymethacrylimides (PMIs) or polyacrylimides (PAIs), especially for PMI or PAI foams, which is not mutagenic or carcinogenic and does not lead to any adverse effect on foamability compared to the prior art.

A further problem was to provide a flame-retardant PMI foam which has at least the same flame retardancy with comparable mechanical properties to the prior art.

It was a further problem to ensure that the foams have at least equally good thermomechanical properties and similarly good processability to the known. PMI foams.

Furthermore, the novel PMI foams should be just as easily producible as the prior art PMI foams.

Further objects which are not stated explicitly are evident from the overall context of the description, claims and examples which follow.

### SOLUTION

The problems were solved by use of dimethyl propyl phosphonate (DMPP) as a flame retardant for poly(meth)acrylimide foams. It has been found that, surprisingly, DMPP is the only commercial flame retardant which is suitable for replacing DMMP in poly(meth)acrylimide foams. Equally surprisingly, it was found that DMPP also has to be used in different, higher concentrations than DMMP.

The term “poly(meth)acrylimide” hereinafter represents both polymethacrylimide (PMI) and polyacrylimide (PAI).

More particularly, the problems were solved by novel foamed poly(meth)acrylamides which had been produced from the following mixture:
(A) 30-70% by weight, preferably 40-60% by weight, of methacrylic acid or acrylic acid,
   30-60% by weight, preferably 30-50% by weight, of methacrylonitrile or acrylonitrile,
   0-30% by weight, preferably 0-10% by weight, of further vinylically unsaturated monomers,
(B) 8-18% by weight, preferably 10-15% by weight, of dimethyl propyl phosphonate,
(C) 0.01-10% by weight, preferably 0.1-5% by weight, of blowing agent,
(D) 0-10% by weight, preferably 0.1-5% by weight of crosslinker,
(E) 0.01-2% by weight, preferably 0.1-1% by weight of polymerization initiators,
(F) 0-10% by weight, preferably 0-5% by weight, of customary additives.

The poly(meth)acrylimide foam is generally obtained by foaming and crosslinking this mixture. More particularly, the poly(meth)acrylimide foam is polymerized in bulk to give a slab which is optionally heat treated. The foaming is subsequently performed at temperatures of 150 to 250° C.

Examples of the further vinylically unsaturated monomers mentioned under (A) are: esters of acrylic or methacrylic acid with lower alcohols having 1-4 carbon atoms, styrene, maleic acid or the anhydride thereof, itaconic acid, or the anhydride thereof, vinylpyrrolidone, vinyl chloride and/or vinylidene chloride. The proportion of the comonomers which can be cyclized only with difficulty, if at all, to give the anhydride or imide should not exceed 30 parts by weight, preferably 20 parts by weight and more preferably 10 parts by weight, based on the weight of the monomers.

The blowing agents (C) used may be the following compounds or mixtures thereof: formamide, formic acid, urea, itaconic acid, citric acid, dicyandiamide, water, monoalkylureas, dimethylurea, 5,5′-azobis(5-ethyl-1,3-dioxane), 2,2′-azobis(N-butylisobutyramide), 2,2′-azobis(N-diethyliso-butyramide), 2,2′,4,4,4′,4′-hexamethyl-2,2′-azopentane, 2,2′-azobis(2-methylpropane), dimethyl carbonate, di-tert-butyl carbonate, acetone cyanohydrin carbonate, methyl hydroxyisobutyrate carbonate, N-methylurethane, N-ethylurethane, N-tert-butylurethane, urethane, oxalic acid, maleic acid, hydroxyisobutyric acid, malonic acid, cyanoformamide, dimethylmaleic acid, tetraethyl methanetetracarboxylate, n-butyl oxamate, trimethyl methanetricarboxylate, triethyl methanetricarboxylate, and also monohydric alcohols composed of 3-8 carbon atoms, e.g. 1-propanol, 2-propanol, 1-butanol, 2-butanol, tert-butanol and isobutanol.

For slight crosslinking, which stabilizes the foam during the foaming procedure and thus enables the production of homogeneous foams, crosslinkers (D) are added. At the same time, heat distortion resistance and creep performance of the foam are improved by crosslinkers. Possible crosslinkers may be divided into two groups: covalent crosslinkers (D1), i.e. copolymerizable polyunsaturated compounds. Examples of such monomers include allyl acrylate, allyl methacrylate, allylacrylamide, allylmethacrylamide, methylenebis(acrylamide) or -(methacrylamide), diethylenebis(allyl carbonate), ethylene glycol diacrylate or ethylene glycol dimethacrylate, diethylene glycol diacrylate or diethylene glycol dimethacrylate, triethylene glycol diacrylate or dimethacrylate, tetraethylene glycol diacrylate or tetraethylene glycol dimethacrylate, tripropylene glycol diacrylate or tripropylene glycol dimethacrylate, 1,3-butanediol diacrylate or 1,3-butanediol dimethacrylate, 1,4-butanediol diacrylate or 1,4-butanediol dimethacrylate, neopentyl diol diacrylate or neopentyl diol dimethacrylate, 1,6-hexanediol diacrylate or 1,6-hexanediol dimethacrylate, trimethylolpropane diacrylate or trimethylolpropane dimethacrylate, trimethylolpropane triacrylate or trimethylolpropane trimethacrylate, pentaerythrityl triacrylate or entaerythrityl trimethacrylate, pentaerythrityl tetraacrylate or pentaerythrityl tetramethacrylate, each of the pentaerythritol derivatives where appropriate also being used in the form of an industrial mixture composed of tri- and tetrafunctional compounds, and also triallyl cyanurate or triallyl isocyanurate. Another useful group is that of ionic crosslinkers (D2). These are polyvalent metal cations which form ionic bridges between the acid groups of the copolymers. Among other examples are the acrylates or methacrylates of the alkaline earth metals or of zinc. Zinc(meth)acrylate and magnesium(meth)acrylate are preferred. The (meth)acrylate salts may also be prepared via dissolution, by way of example, of ZnO or MgO in the monomer mixture.

Alternatively, the foam may also be uncrosslinked.

The initiators (E) used are compounds and initiator systems which can initiate free-radical polymerization reactions. Known classes of compounds are peroxides, hydroperoxides, peroxodisulphates, percarbonates, perketals, peroxyesters, hydrogen peroxide and azo compounds. Examples of initiators are hydrogen peroxide, dibenzoyl peroxide, dicyclohexyl peroxodicarbonate, dilauryl peroxide, methyl ethyl ketone peroxide, acetylacetone peroxide, di-tert-butyl peroxide, tert-butyl hydroperoxide, cumene hydroperoxide, tert-butyl peroctanoate, tert-butyl 2-ethylperhexanoate, tert-butyl perneodecanoate, tert-amyl perpivalate, tert-butyl perpivalate, tert-butyl perbenzoate, lithium peroxodisulphate, sodium peroxodisulphate, potassium peroxodisulphate and ammonium peroxodisulphate, azoisobutyronitrile, 2,2-azobis(2,4-dimethyl-isovaleronitrile), 2,2-azobis(isobutyronitrile), 2,2′-azobis(2-amidinopropane)dihydrochloride, 2-(carbamoylazo)isobutyronitrile and 4,4′-azobis(cyanovaleric acid). Redox initiators are equally suitable (H. Rauch-Puntigam, Th. Völker, Acryl- and Methacrylverbindungen [Acrylic and Methacrylic Compounds], Springer, Heidelberg, 1967 or Kirk-Othmer, Encyclopedia of Chemical Technology, Vol. 1, pages 286 ff., John Wiley & Sons, New York, 1978). It may be advantageous to combine initiators and initiator systems with different decomposition properties in relation to time and temperature. The initiators (E) are preferably used in amounts of 0.01 to 2 parts by weight, more preferably of 0.15 to 1.5 parts by weight, based on the total weight of the monomers.

In addition, conventional additives (F) may be added to the mixtures. These include antistats, antioxidants, mould release agents, lubricants, dyes, flow improvers, fillers, light stabilizers, pigments, separating agents, weathering stabilizers and plasticizers.

The poly(meth)acrylimide foams produced in accordance with the invention can be used to produce laminate materials. Laminate materials comprise materials provided with a solid material on one side, and likewise sandwich materials in which the foam is surrounded by solid material on both sides. The solid materials may be films or sheets. These may consist of metal, wood or preferably other polymeric materials. The bond can be effected by means of adhesion, fusion or sewing.

Alternatively, it is possible to place fibrous structures, typically composed of carbon fibres or glass fibres, into a mould together with the foam, then to impregnate them with resin and to cure the charge.

The inventive poly(meth)acrylimide foams or the laminate materials produced therefrom have a wide field of use. They can be used in motor vehicles, rail vehicles, air vehicles, water vehicles, space vehicles, machine parts, antennas, X-ray tables, loudspeakers and pipes.

The examples given hereinafter are given for better illustration of the present invention, but are not capable of restricting the invention to the features disclosed therein.

### EXAMPLES

The foaming appearance was assessed visually. This involved making a comparison with the prior art according to Comparative Example 1.

The fire tests and the assessment of the results from the fire tests were in accordance with standard FAR 25.853.

The density was determined in accordance with ISO 845.

### Comparative Example 1: DMMP

To a mixture of 2800 g of methacrylic acid, 2110 g of methacrylonitrile and 5.9 g of allyl methacrylate were added 66 g of water and 69 g of formamide as blowing agents. Additionally added to the mixture were 2.0 g of tert-butyl perpivalate, 1.5 g of tert-butyl per-2-ethyl-hexanoate, 4.9 g of tert-butyl perbenzoate, 4.9 g of cumyl perneodecanoate, 35 g of zinc oxide and 9.8 g of separating agent (Moldwiz INT 20E). The flame retardant added was 491 g of DMMP.

This mixture was polymerized at 39° C. for 68 h in a chamber formed from two glass plates of 50×50 cm in size with an edge seal of thickness 28 mm.

Subsequently, the polymer was heat treated for final polymerization at a temperature rising from 32° C. to 115° C. over the course of 32 h.

The subsequent foaming by the hot air method was effected at 201° C. over the course of 2 h. The foam thus obtained had a density of 118 kg/m³. A further sample was foamed at 219° C. for 2 h. The foam thus obtained had a density of 76 kg/m³.

The foams have a homogeneous foaming appearance and satisfied the requirements of the fire test in full.

### Example 1: DMPP

To a mixture of 2400 g of methacrylic acid, 2400 g of methacrylonitrile and 9.6 g of allyl methacrylate were added 144 g of formamide as a blowing agent. Additionally added to the mixture were 1.9 g of tert-butyl perpivalate, 1.4 g of tert-butyl per-2-ethylhexanoate, 4.8 g of tert-butyl perbenzoate, 4.8 g of cumyl perneodecanoate, 33.5 g of zinc oxide and 9.6 g of separating agent (Moldwiz INT 20E). The flame retardant used was 600 g of DMPP.

This mixture was polymerized at 40° C. for 72 h in a chamber formed from two glass plates of size 50×50 cm with an edge seal of thickness 28 mm. Subsequently, the polymer was heat treated for final polymerization at a temperature rising from 32° C. to 115° C. over the course of 32 h.

The subsequent foaming by the hot air method was effected at 203° C. for 2 h. The foam thus obtained had a density of 108 kg/m³. A further sample was foamed at 219° C. for 2 h. The foam thus obtained had a density of 70 kg/m³.

The foams from Example 1 have a homogeneous foaming appearance which is not noticeably distinguishable from the foaming from Comparative Example 1. Both foams met the requirements of the fire test in full.

### Comparative Example 2: Vinylphosphonic Acid

To a mixture of 280 g of methacrylic acid, 211 g of methacrylonitrile and 590 mg of allyl methacrylate were added 6.6 g of water and 6.9 g of formamide as blowing agents. Additionally added to the mixture were 200 mg of tert-butyl perpivalate, 150 mg of tert-butyl per-2-ethyl-hexanoate, 49 mg of tert-butyl perbenzoate, 49 mg of cumyl perneodecanoate, 3.5 g of zinc oxide and 980 mg of separating agent (Moldwiz INT 20E). The flame retardant added was 42.7 g of vinylphosphonic acid.

This mixture was polymerized in glass ampoules at 50° C. for 44 h. Subsequently, the polymer was heat treated for final polymerization at a temperature rising from 32° C. to 115° C. over the course of 32 h. The polymer was inhomogeneous.

The subsequent foaming by the hot air method was effected at 220° C. for 2 h. The foam thus obtained had a density of 141 kg/m³. A further sample was foamed at 230° C. for 2 h. The foam thus obtained had a density of 102 kg/m³. Both samples foamed inhomogeneously and failed fire tests.

### Comparative Example 3: Dimethyl Vinylphosphonate

The amounts and procedure were analogous to Comparative Example 2. The flame retardant used was 53.8 g of dimethyl vinylphosphonate.

This mixture was polymerized in glass ampoules at 50° C. for 20 h. Subsequently, the polymer was heat treated for final polymerization at a temperature rising from 32° C. to 115° C. over the course of 32 h. The polymer was inhomogeneous.

The subsequent foaming by the hot air method was effected at 200° C. for 2 h. The foam thus obtained had a density of 80 kg/m³. A further sample was foamed at 210° C. for 2 h. The foam thus obtained had a density of 58 kg/m³. Both samples foamed inhomogeneously and failed fire tests.

### Comparative Example 4: Exolit OP 550 (from Clariant)

The amounts and procedure were analogous to Comparative Example 2. The flame retardant used was 72.2 g of Exolit OP 550.

This mixture was polymerized in glass ampoules at 50° C. for 41.5 h. Subsequently, the solid but cloudy polymer was heat treated for final polymerization at a temperature rising from 32° C. to 115° C. over the course of 32 h.

The subsequent foaming by the hot air method was unsuccessful. The samples did not foam.

### Comparative Example 5: Exolit OP 560 (from Clariant)

The amount and procedure were analogous to Comparative Example 2. The flame retardant used was 102.1 g of Exolit OP 560.

This mixture was polymerized in glass ampoules at 50° C. for 41.5 h. Subsequently, the cloudy and partly still liquid polymer was heat treated for final polymerization at a temperature rising from 32° C. to 115° C. over the course of 32 h.

The subsequent foaming by the hot air method was unsuccessful. The samples did not foam.

The selection of flame retardants detailed here in Comparative Examples 2 to 5 shows that none of the conventionally used flame retardants is suitable for producing a stable, fire-resistant and simultaneously homogeneous foam. Only DMPP, used in accordance with the invention, leads to a result comparable to the prior art. And this is the case preferably only when it is used in a higher concentration than DMMP.

1. A poly(meth)acrylimide foam comprising dimethyl propyl phosphonate.

2. The poly(meth)acrylimide foam to of claim 1, obtained from a mixture comprising
(A) 30 to 70% by weight of methacrylic acid or acrylic acid,
30 to 60% by weight of methacrylonitrile or acrylonitrile,
0 to 30% by weight of a further vinylically unsaturated monomer,
(B) 8 to 18% by weight of dimethyl propyl phosphonate,
(C) 0.01 to 10% by weight of a blowing agent,
(D) 0 to 10% by weight of a crosslinker,
(E) 0.01 to 2% by weight of a polymerization initiator,
(F) 0 to 10% by weight of a customary additive.

3. The poly(meth)acrylimide foam of claim 2, wherein the mixture comprises
(A) 40 to 60% by weight of methacrylic acid or acrylic acid,
30 to 50% by weight of methacrylonitrile or acrylonitrile,
0 to 10% by weight of a further vinylically unsaturated monomer,
(B) 10 to 15% by weight of dimethyl propyl phosphonate,
(C) 0.1 to 5% by weight of a blowing agent,
(D) 0.1 to 5% by weight of a crosslinker,
(E) 0.1 to 1% by weight of a polymerization initiator,
(F) 0 to 5% by weight of a customary additive.

4. The poly(meth)acrylimide foam of claim 2, obtained by foaming and crosslinking components (A)-(F).

5. The poly(meth)acrylimide foam of claim 1, obtained by bulk polymerization to give a slab which is optionally heat treated and then foamed at temperatures of 150 to 250° C.

6. A laminate material comprising a layer of the poly(meth)acrylimide foam of claim 1.

7. A motor vehicle, a rail vehicle, a water vehicle, an air vehicle, or a space vehicle comprising a poly(meth)acrylimide foam of claim 1.

8. A machine part, an antenna, an X-ray table, a loudspeaker, or a pipe comprising the poly(meth)acrylimide foam of claim 1.

9. The poly(meth)acrylimide foam of claim 2, wherein the mixture comprises 30 to 70% by weight of methacrylic acid.

10. The poly(meth)acrylimide foam of claim 2, wherein the mixture comprises 30 to 70% by weight of acrylic acid.

11. The poly(meth)acrylimide foam of claim 2, wherein the mixture comprises 30 to 60% by weight of methacrylonitrile.

12. The poly(meth)acrylimide foam of claim 2, wherein the mixture comprises 30 to 60% by weight of acrylonitrile.

13. The poly(meth)acrylimide foam of claim 2, wherein the mixture comprises methacrylic acid, methacrylonitrile, and allyl methacrylate.

14. The poly(meth)acrylimide foam of claim 2, wherein the mixture comprises at least one further vinylically unsaturated monomer selected from the group consisting of an ester of acrylic acid with a lower alcohol having 1 to 4 carbon atoms, an ester of methacrylic acid with a lower alcohol having 1 to 4 carbon atoms, styrene, maleic acid, maleic acid anhydride, itaconic acid, itaconic acid anhydride, vinylpyrrolidone, vinyl chloride, and vinylidene chloride.

15. The poly(meth)acrylimide foam of claim 2, wherein the blowing agent is at least one selected from the group consisting of formamide, formic acid, urea, itaconic acid, citric acid, dicyandiamide, water, monoalkylureas, dimethylurea, 5,5′-azobis(5-ethyl-1,3-dioxane), 2,2′-azobis(N-butylisobutyramide), 2,2′-azobis(N-diethylisobutyramide), 2,2′,4,4,4′,4′-hexamethyl-2,2′-azopentane, 2,2′-azobis(2-methylpropane), dimethyl carbonate, di-tert-butyl carbonate, acetone cyanohydrin carbonate, methyl hydroxyisobutyrate carbonate, N-methylurethane, N-ethylurethane, N-tert-butylurethane, urethane, oxalic acid, maleic acid, hydroxyisobutyric acid, malonic acid, cyanoformamide, dimethylmaleic acid, tetraethyl methanetetracarboxylate, n-butyl oxamate, trimethyl methanetricarboxylate, triethyl methanetricarboxylate, and also monohydric alcohols composed of 3-8 carbon atoms, e.g. 1-propanol, 2-propanol, 1-butanol, 2-butanol, tert-butanol and isobutanol.

16. The poly(meth)acrylimide foam of claim 2, wherein the mixture comprises at least one covalent crosslinker selected from the group consisting of allyl acrylate, allyl methacrylate, allylacrylamide, allylmethacrylamide, methylenebis(acrylamide), methylenebis(methacrylamide), diethylenebis(allyl carbonate), ethylene glycol diacrylate, ethylene glycol dimethacrylate, diethylene glycol diacrylate, diethylene glycol dimethacrylate, triethylene glycol diacrylate, dimethacrylate, tetraethylene glycol diacrylate, tetraethylene glycol dimethacrylate, tripropylene glycol diacrylate, tripropylene glycol dimethacrylate, 1,3-butanediol diacrylate, 1,3-butanediol dimethacrylate, 1,4-butanediol diacrylate, 1,4-butanediol dimethacrylate, neopentyl diol diacrylate, neopentyl diol dimethacrylate, 1,6-hexanediol diacrylate, 1,6-hexanediol dimethacrylate, trimethylolpropane diacrylate, trimethylolpropane dimethacrylate, trimethylolpropane triacrylate, trimethylolpropane trimethacrylate, pentaerythrityl triacrylate, pentaerythrityl trimethacrylate, pentaerythrityl tetraacrylate, and pentaerythrityl tetramethacrylate.

17. The poly(meth)acrylimide foam of claim 2, wherein the mixture comprises at least one ionic crosslinker selected from the group consisting of an acrylate of an alkaline earth metal, and a methacrylate of an alkaline earth metal.

18. The poly(meth)acrylimide foam of claim 2, wherein the mixture comprises at least one ionic crosslinker selected from the group consisting of zinc (meth)acrylate and magnesium (meth)acrylate.

19. The poly(meth)acrylimide foam of claim 2, wherein the mixture comprises at least one initiator selected from the group consisting of hydrogen peroxide, dibenzoyl peroxide, dicyclohexyl peroxodicarbonate, dilauryl peroxide, methyl ethyl ketone peroxide, acetylacetone peroxide, di-tert-butyl peroxide, tert-butyl hydroperoxide, cumene hydroperoxide, tert-butyl peroctanoate, tert-butyl 2-ethylperhexanoate, tert-butyl perneodecanoate, tert-amyl perpivalate, tert-butyl perpivalate, tert-butyl perbenzoate, lithium peroxodisulphate, sodium peroxodisulphate, potassium peroxodisulphate and ammonium peroxodisulphate, azoisobutyronitrile, 2,2-azobis(2,4-dimethylisovaleronitrile), 2,2-azobis-(isobutyronitrile), 2,2′-azobis(2-amidinopropane) dihydrochloride, 2-(carbamoylazo)isobutyronitrile and 4,4′-azobis(cyanovaleric acid).

20. The poly(meth)acrylimide foam of claim 2, wherein the mixture comprises at least one customary additive selected from the group consisting of an antistat, an antioxidant, a mould release agent, a lubricant, a dye, a flow improver, a filler, a light stabilizer, a pigment, a separating agent, a weathering stabilizer and a plasticizer.
